(19) United States
(12) Patent Application Publication
(10) Pub. No.: US 2025/0244741 A1
(43) Pub. Date: Jul. 31, 2025

(54) Real-Time Collision Detection and Illuminated Guidance System Using Computer Vision

(71) Applicant: Justin Daniel Albert Kilb, Lakewood, CO (US)

(72) Inventor: Justin Daniel Albert Kilb, Lakewood, CO (US)

(21) Appl. No.: 18/423,143

(22) Filed: Jan. 25, 2024

(51) Int. Cl. G05B 19/4061; G06V 10/141; G06V 20/52; G06V 40/10; G06V 40/20; G08B 5/36; G08B 21/02

(52) U.S. Cl. CPC G05B 19/4061; G06V 10/141; G06V 20/52; G06V 40/10; G06V 40/20; G08B 5/36; G08B 21/02

(57) ABSTRACT

The disclosed invention introduces an advanced Visual Alarm and Guidance System designed to significantly enhance safety in industrial environments. This innovative system integrates state-of-the-art computer vision and light projection technologies, along with trajectory prediction algorithms, to dynamically identify potential hazards and guide workers in real-time out of potential collision pathways. It marks a considerable advancement over traditional safety methods by not only detecting imminent dangers but also providing clear, visual navigation aids. This system is adaptable to various high-risk settings, seamlessly integrates with existing infrastructures, and offers a novel approach to real-time, visual safety management in industrial settings.

### FIELD OF THE INVENTION

This invention belongs to the field of industrial safety and operational guidance technologies, with a specialized focus on advanced collision prediction and avoidance mechanisms. The invention specifically addresses the need for dynamic, real-time safety solutions in high-risk industrial environments where traditional monitoring and alert systems prove inadequate. It introduces a new system that combines advancements in computer vision, optical physics, visible light projection, and trajectory prediction algorithms.

### DESCRIPTION OF RELATED ART

Current safety mechanisms in industrial settings predominantly revolve around traditional methods, including manual human supervision or machine auditory alerts. A critical review of these technologies reveals a significant gap: the lack of an integrated system capable of real-time, trajectory-based analysis combined with proactive visual illumination alerts.

For instance, some existing patents use computer vision-based monitoring systems, which, while potentially effective in object detection, lacks the capability to predict generalized industrial object collision courses and provide visual directional guidance. Furthermore, existing patents use auditory alert systems for industrial safety, which, despite its ability to signal the presence of hazards, fails to offer spatial or directional awareness to human workers. These examples underscore a persistent limitation in the field: the absence of a system that marries real-time dynamic object tracking with intuitive, spatially aware visual guidance.

This invention addresses these shortcomings by introducing a visual illumination alarm system utilizing principles like Rayleigh scattering to project clearly visible light paths along potential collision trajectories. Unlike its predecessors, this system not only alerts workers to imminent dangers but also visually guides them to safety, a feature absent in existing technologies. The innovation lies in its ability to analyze diverse industrial environments in real time, predict potential collisions with high accuracy, and immediately communicate this information through a visual medium that is interpretable to humans regardless of loud working environments. Such a system represents a significant leap in industrial safety technology, with the potential to significantly reduce human injury.

### SUMMARY OF THE INVENTION

This invention comprises two primary components:
1) A trajectory prediction module that utilizes computer vision analysis to accurately forecast potential collision events. This module is designed to analyze real-time data and predict the movement of various objects within an industrial setting, thereby identifying potential hazards to human workers.
2) An innovative visual alarm system which employs advanced light projection techniques to display visible paths in the air and on the ground. These paths mark the trajectories of moving objects, thereby visually alerting workers to potential collision courses.

### BRIEF DESCRIPTION OF DRAWINGS

FIG. 1 illustrates the process of illuminating a potential object and human collision course, which includes a human worker 100 working in an industrial environment 102. As an example of a potentially hazardous moving object, a hanging cylindrical pipe 105 is on a collision course 110 with a human. FIG. 1 has four sub figures. The first scenario labeled A is the environment and initial location of the human and the object. The scenario labeled B, C, and D are subsequent and sequential steps in time in which the object approaches the human on a collision course 110.

FIG. 2 shows the process flow of the software program, henceforth referred to as the program, which analyzes the data stream and correspondingly interacts with the system components. This process begins with the camera input 104, followed by intermediary computation and algorithms, and finally the illumination of light along the potential collision path.

### DETAILED DESCRIPTION OF THE INVENTION

The present invention introduces an advanced trajectory-based visual alarm and guidance system, utilizing light scattering principles, specifically designed to enhance industrial safety. This system integrates computer vision with a novel visual alarm mechanism, using real-time video data to project visible light paths that delineate potential collision trajectories and safe pathways for personnel.

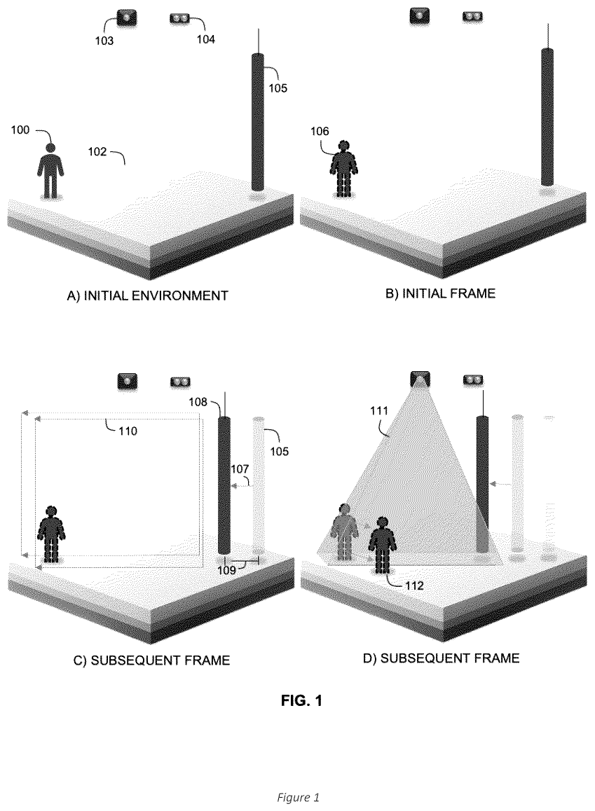

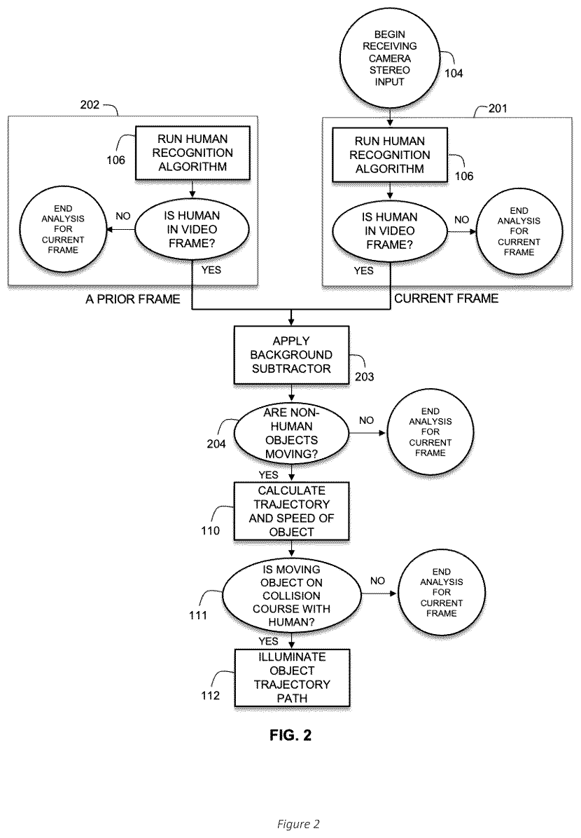

The program begins with video data acquisition, employing a video camera setup to capture a three-dimensional perspective of the industrial environment. This approach enables depth perception, a critical factor in analyzing the distance to and size of objects, thus enabling subsequent trajectory prediction that works in a three-dimensional space. FIG. 1, 104 represents the video capture system, which is placed at a location that allows it to record the area of interest. The video data stream that is captured by this device is analyzed by the program and follows the program in FIG. 2.

A video is a series of combined sequential static images, which will be referred to as frames henceforth. Thus, the program performs analysis on individual frames, which represent discrete captures of time. FIG. 2 illustrates the program, which begins with 104. The first frame of the video, which represents the first recorded image, is analyzed to search for humans using object recognition algorithms capable of identifying human FIGS. 106. Various machine learning models, including but not limited to convolutional neural networks and recurrent neural networks, can be employed for accurate human figure recognition, and tracking across multiple frames. This is potentially done by contouring the human shape, thus creating an outline with bounds that can be monitored through space during subsequent analysis.

To identify moving objects, the program observes changes in video frame pixel values frame over frame. FIG. 2 shows this type of comparative analysis. 201 shows analysis performed on the most recently captured frame. 202 is the same analysis but performed on a prior frame. If a human is recognized in both the current frame and a prior frame, then the program proceeds to the following analysis. This conditional step alleviates unnecessary subsequent analysis if no humans are in both frames. If a human is identified in the current and a prior frame, a method like background subtraction 203 can be used by analyzing both frames to distinguish between static elements and dynamic elements. By comparing frames, the system can detect changes in the scene attributable to the movement of objects or humans. These types of algorithms have been designed to be robust against variations in lighting and environmental conditions, ensuring consistent and reliable detection of moving objects within the industrial setting.

If there is a human present, but non-human objects are not moving 204, the program can terminate for the most recent frame, thus alleviating unnecessary processing. If a human is present and non-human objects are moving, the trajectory and speed of the moving objects will be calculated in step 110.

Upon detecting movement of a non-human object, the system engages an algorithmic process to calculate the trajectory and speed of both the object and any nearby humans. This is fundamental to the system's collision prediction and prevention capabilities. Drawing from the data captured with the current and preceding frames, the trajectory prediction module determines the vector paths of moving entities. FIG. 1 scenario C shows this evolution, which would be captured in multiple frames and processed according to FIG. 2. Multiple frames show that the original location of the non-human object FIG. 1 105 has moved 107 to its new location 108. Utilizing mathematical concepts such as vector calculus and kinematics, the system computes the speed and direction of each entity by measuring the change in their position across frames 109, relative to time. The trajectory 110 is determined by mapping the positional coordinates of the entities over time, creating a linear or non-linear vector that predicts their future positions based on current movement patterns. This method, rooted in mathematical analysis, allows for an accurate prediction of potential collision points by considering the intersecting vectors of the moving objects and humans within the monitored area.

Following the assessment of object trajectories and collision risks, the system activates its visual alarm mechanism, a cornerstone of this invention. This lighting system leverages principles of optics, such as Rayleigh scattering, to project visible, clearly defined light paths along the trajectories where potential collisions are predicted. The system utilizes the previously calculated collision coordinates 110, stored by the trajectory prediction module, as reference coordinates for light projection. By employing a combination of light sources and optical elements, the system casts bright, discernible light beams along the paths where collisions are anticipated, effectively alerting personnel to potential hazards 111. The illumination is precisely aligned with the linear or non-linear predicted trajectories, ensuring that the light paths accurately represent the movement vectors of the moving objects. This alignment is achieved through a dynamic adjustment mechanism, which modifies the light projection in real-time, frame over frame, to match any changes in the predicted collision paths.

Furthermore, the use of visible light principles like Rayleigh scattering enhances the visibility of these light paths, making them conspicuous even in diverse lighting conditions typical of industrial environments. The visual alarm system thereby serves a dual purpose: it provides an immediate warning signal and visually delineates safe zones for personnel, that being any area that is not currently illuminated. This integration of collision prediction data with a responsive lighting system represents a novel approach to industrial safety, combining the precision of mathematical calculations and computer vision with the practical application of optical technologies for real-time hazard prevention. Most importantly, the illuminated light beam allows human workers to exit the path of collision immediately 112, unlike existing and commonly employed alarm systems, which are sound based and thus lack a spatial visible dimension. In other words, sound alarms do not tell workers which way to move, only that a potential hazardous situation is occurring.

This invention marks an advancement in the realm of industrial safety. By offering real-time, visually guided alerts based on sophisticated trajectory prediction, it surpasses traditional safety mechanisms, which often rely on auditory signals or static visual cues. The novel application of visible light path projection enhances the system's effectiveness in diverse lighting conditions, particularly in noisy, and diverse industrial environments.

The system's versatile nature allows for its adaptation to other environments requiring dynamic safety measures, such as construction sites or logistics centers. Modifications can include recalibration of light path colors and intensities, as well as the integration of different algorithmic approaches to suit varied operational contexts.

In conclusion, the invention presents a novel solution in safety technology, combining advanced motion analysis, projection technology, and real-time tracking. Its innovative approach, characterized by the integration of computer vision, sophisticated algorithmic processing, and illuminated guidance systems, establishes a new standard in dynamic safety management and one that can save lives.

A system for enhancing safety in industrial settings, comprising:

1. An imaging system capable of capturing data in a variety of industrial environments;
a. A processing unit configured with algorithms for analyzing data to identify and track moving entities and assess potential hazards;
b. A module for predicting the movement and possible collision courses of detected entities, using motion analysis techniques;
c. A visual alert system, operating on principles of light scattering, to project discernible alerts in response to predicted risks;
d. Wherein the system provides dynamic, real-time visual guidance and warnings, adaptable to different industrial settings.

2. The safety system of claim 1, where the visual alarm system dynamically adjusts light paths using an algorithm that responds in real-time to changes in predicted collision paths, enhancing situational awareness.

3. The safety system of claim 1, further including an algorithm within the trajectory prediction module for detailed collision risk assessment, capable of predicting future positions of detected entities based on their movement patterns.

4. The safety system of claim 1, wherein the visual alarm system delineates safe zones not currently under predicted collision paths and illumination, with these zones being dynamic and visually distinct to guide personnel effectively.

5. The safety system of claim 1, characterized by the substitution of traditional sound-based alarms with a visual alarm system that projects light paths, wherein the visual alarm system uses visible, light-scattered light paths in the air, offering a clear and immediate visual cue for collision avoidance and safety guidance, particularly effective in noisy industrial environments where sound-based alarms may be less discernible and lacking directional guidance to avoid the collision.

6. A method for enhancing safety in industrial environments, involving:
a. Capturing environmental data using an imaging system;
b. Analyzing the data with a processing unit to identify potential hazards;
c. Predicting movement and collision courses of detected entities using a motion analysis module;
d. Projecting visual alerts using a light scattering-based alarm system in response to predicted risks;
e. Dynamically adjusting the visual alerts in real-time based on changes in predicted collision paths.

7. The method of claim 6, wherein the step of projecting visual alerts includes using a light-scattering technique to generate discernible light paths along the trajectories of predicted collisions.

8. A computer-implemented process for collision prediction in industrial settings, including:
a. Real-time data capture from a depth-perceptive imaging system;
b. Utilizing algorithms for object recognition and movement tracking;
C. Analyzing frame-by-frame data to identify and assess movement of entities;
d. Calculating trajectory and collision risks using advanced computational methods;
e. Activating a responsive visual alarm system based on the calculated risks.

9. The process of claim 8, further including adapting the visual alarm system to be compatible with various industrial environments and safety protocols.

10. The process of claim 8, wherein the visual alarm system includes optimizing the light paths for visibility under diverse environmental lighting conditions.
